(19) United States
(12) Patent Application Publication
(10) Pub. No.: US 2001/0039200 A1
(43) Pub. Date: Nov. 8, 2001

(54) Portable communications equipment

(76) Inventors: Henry Azima, Cambridge (GB); Neil Simon Owen, Cambridgeshire (GB); David Gamble, Cambs (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/838,567

(22) Filed: Apr. 20, 2001

Related U.S. Application Data
(60) Provisional application No. 60/218,052, filed on Jul. 13, 2000.

(30) Foreign Application Priority Data
Apr. 20, 2000 (GB) 0009704.8

(51) Int. Cl. H04B 1/38

(52) U.S. Cl. 455/575; 455/66; 455/344; 455/350; 379/433.02

(57) ABSTRACT

The combination of a personal portable communications device having an audio output intended for use when proximate to a user's ear, and a physically separable accessory to amplify the audio output of the communications device for remote reception. The accessory comprises a bending wave panel-form acoustic radiator, and the communications device has a vibration transducer for coupling to the radiator to drive bending wave energy into the radiator to produce an acoustic output therefrom.

This application claims the benefit of U.S. Provisional Application Serial No. 60/218,052, filed Jul. 13, 2000.

### BACKGROUND

The invention relates to portable communications equipment, e.g. personal communications equipment, such as mobile telephones or data organisers.

It is a problem for small portable personal communications devices such as mobile telephones, hereinafter “mobile phones” and the like, to achieve a sufficient sound output to be effective other than when directly adjacent to the user's ear, for example, at a distance for use simultaneously by more than one person, e.g. as in a conference call, or in a noisy environment.

It will be appreciated that mobile phones are known having sound outputs which can be adjusted between a personal use position, in which the phone is held proximate to the user's ear, and a second position in which the sound level from the phone is higher for remote use. However, the performance of such devices is somewhat disappointing, and there is a need for a device of this type having improved sound output.

### SUMMARY OF THE INVENTION

It is, therefore, an object of the invention to provide an arrangement whereby portable personal communications equipment can achieve higher sound levels.

According to the invention, there is provided the combination of a personal portable communications device having an audio output intended for use when proximate to a user's ear, and a physically separable accessory to amplify the audio output of the communication device for remote reception, the accessory comprising a bending wave panel-form acoustic radiator, and the communications device comprising a vibration transducer capable of being detachably coupled to the radiator to drive bending wave energy into the radiator to produce an acoustic output therefrom. The radiator may operate as a resonant panel loudspeaker, e.g. a distributed mode loudspeaker (DML) as set out in WO97/09842 and counterpart U.S. application Ser. No. 08/707,012, filed Sep. 3, 1996. The separate accessory may be as simple as a single piece of flat or shaped material, e.g. a panel, or a complex docking station containing many features such as power supply, additional displays etc.

### BRIEF DESCRIPTION OF THE DRAWING

Examples that embody the best mode of carrying out the invention are described in detail below and are diagrammatically illustrated in the accompanying drawing, in which:

FIG. 1 is a side elevational view of a first embodiment of the invention;

FIG. 2 is a top plan view of the embodiment of FIG. 1;

FIG. 3 is a side elevational view of a second embodiment of the invention;

FIG. 4 is a front elevational view of the embodiment of FIG. 3;

FIG. 5 is a side elevational view of a third embodiment of the invention;

FIG. 6 is a side elevational view of a fourth embodiment of the invention; and

FIG. 7 a comparative frequency response graph.

### DETAILED DESCRIPTION

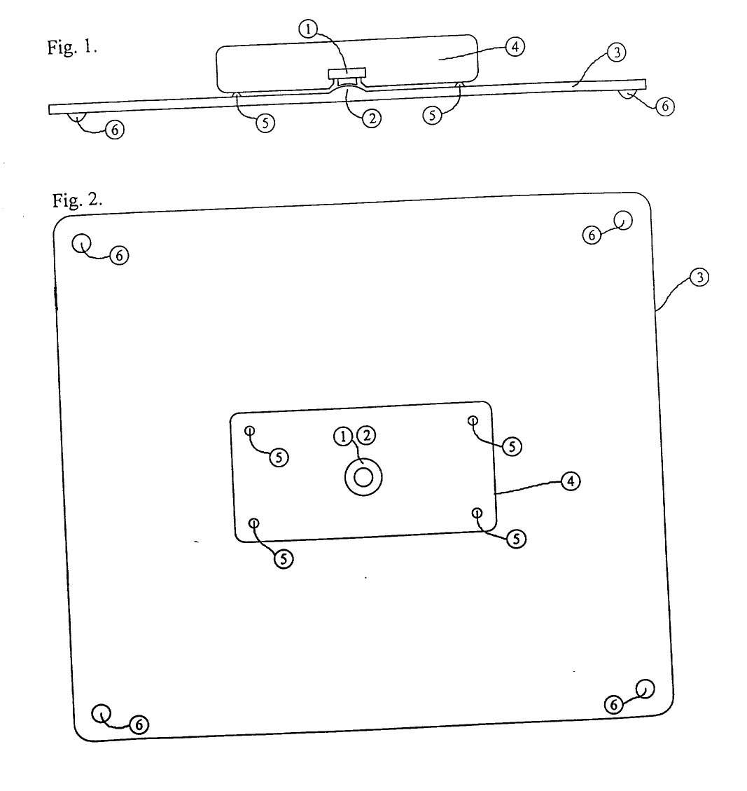

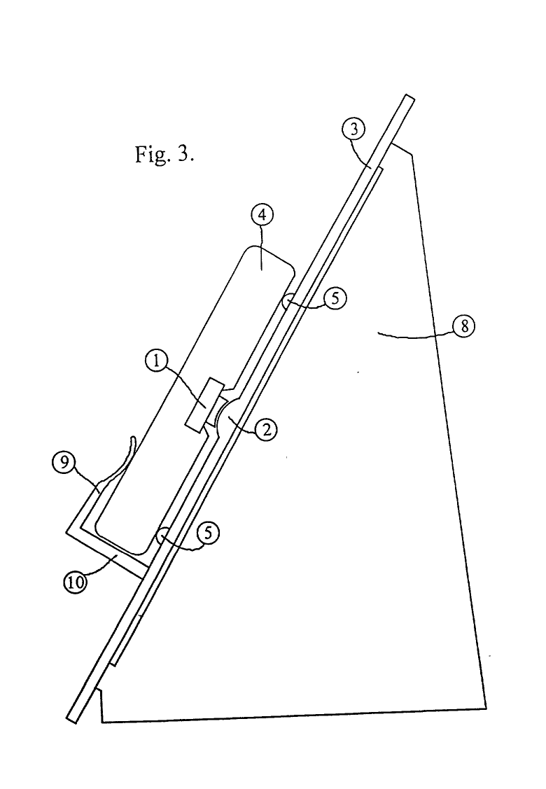

In FIGS. 1 and 2 of the drawing there is shown an accessory object or device for amplifying the sound output of an electronic personal portable communications device (4), e.g. a mobile phone, the accessory device comprising a generally rectangular rigid lightweight bending wave acoustic radiator panel (3) having downwardly facing compliant ground engaging projections (6) near its corners and adapted to lay flat above a suitable ground or other supporting surface (not shown), e.g. a desk top, so as to be raised from the surface by the projections (6) which thus form feet. The panel is adapted to carry the mobile phone or other device (4) on upstanding compliant projections (5) extending from the upper surface of the panel so that the device (4) is raised from the surface of the panel. The panel is formed with a domed portion (2) adapted to couple to a vibration exciter or transducer (1) in the device (4) so that the exciter (1) can drive bending wave vibration into the panel (3) to produce an acoustic output, e.g. as taught in WO97/09842 and U.S. application Ser. No. 08/707,012 (the latter incorporated herein by reference). In this way the acoustic output from the device (4) can be amplified at low cost.

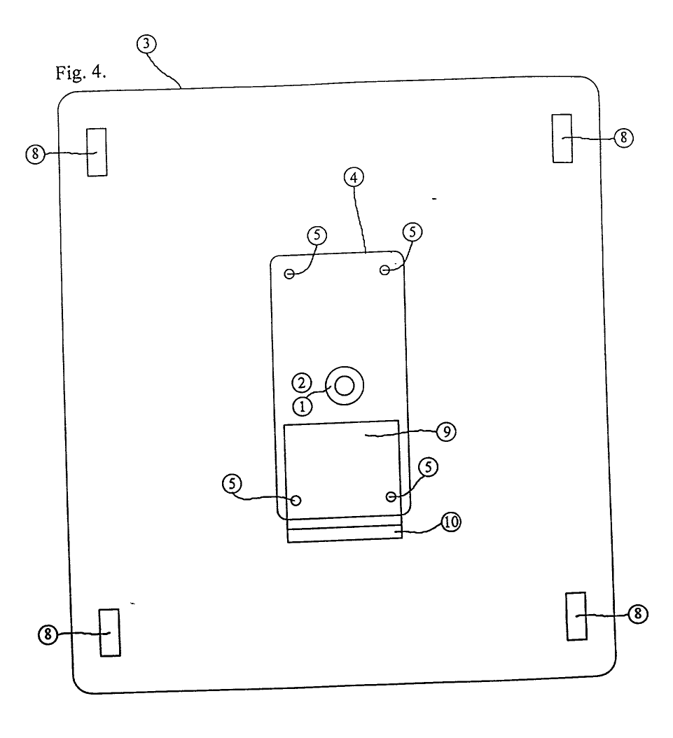

The device of FIGS. 3 and 4 is generally similar to that described above, but in this case the panel (3) is inclined or generally upright, supported by a stand or feet in the form of side brackets (8) engaging the panel (3) near its corners. Due to the incline, the device (4) is removably supported on a spring bracket (9,10) on the panel, so that its vibration exciter (1) is coupled to the panel via domed portion (2).

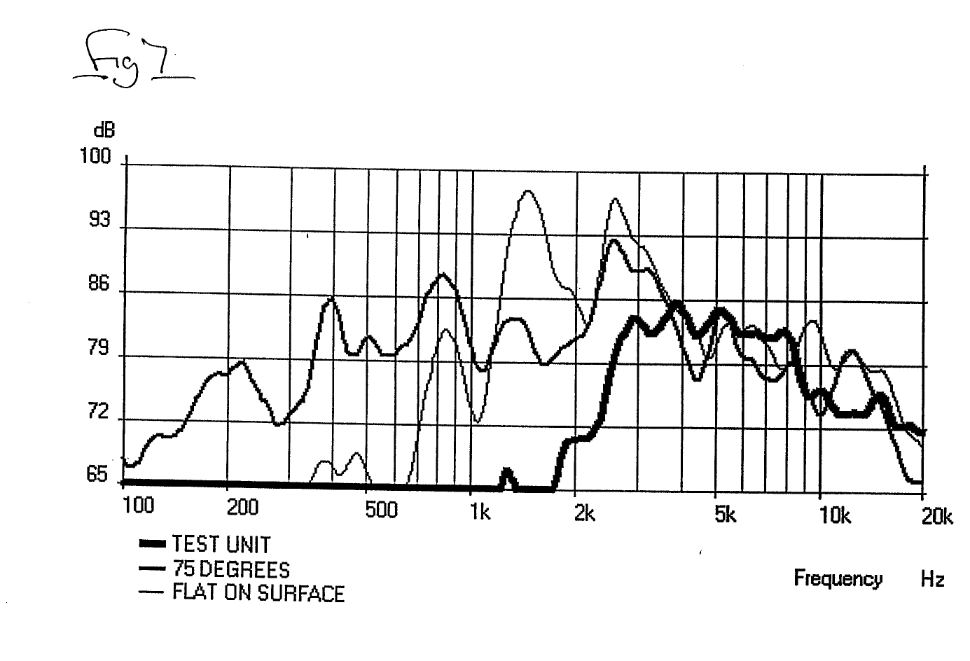

Referring to FIG. 6, the electronic equipment, e.g. mobile phone, (4) may already contain a built-in bending wave panel or other loudspeaker (7) from which the excitation for the accessory panel (3) can be obtained. The accessory panel (3) can then amplify the acoustic output to provide a more clearly audible signal of greater loudness, bandwidth or both. A reduction in distortion might also be possible from certain configurations. Domed portion (2) is a mechanical coupler that is the route by which the vibration force is imparted to the accessory panel (3). The properties of the coupler (2) may be tailored to achieve the required result but in general a longitudinally stiff connection would be appropriate, i.e., stiff in the direction normal to the plane of panel (3).

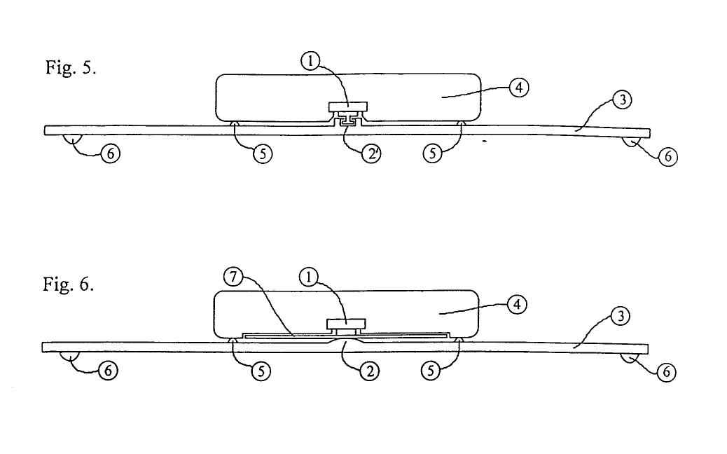

The coupler (2) preferably is operated in compression (i.e., preloaded) such that the variations in force due to the vibration components do not cause disconnection of the coupler. In FIGS. 1, 2 and 6 this is achieved using the force of gravity, i.e. using the weight of the equipment (4) bearing on the coupler (2). Alternatively, a deformable, channel-like locking coupling (2′) as shown in FIG. 5 may be employed, which is able to carry the force due to vibration without separating the excitation device (1) from the panel (3). For removal, the electronic device (4) is separated from the panel (3) by using a force parallel to the plane of panel (3), or a force greater than that due to vibration along the same axis as the coupled vibration (i.e., perpendicular to the plane of panel (3)). Magnetic, snap-type and other forms of detachable coupling may also be used.

In the embodiment of FIGS. 3 and 4 a preload force is imparted on the coupler (2) by the spring clip (9,10). The spring itself (9) may be dispensed with if the gravitational force is sufficient to maintain contact between vibration exciter (1) and coupler (2) for good operation.

In all embodiments the supports for the panel (3) (stand or feet (8, 6)) preferably are coupled to the bending wave panel (3) at points of low vibrational activity (e.g., nodes) as determined by DML design rules as set out in WO97/09842 and U.S. application Ser. No. 08/707,012 so that the supports do not unduly affect the performance of the panel. Similarly the position at which the device (4) is coupled to the panel (3) may also be determined by DML design rules to effect the required performance.

FIG. 7 shows comparative frequency response results of a test mobile phone when used in conventional fashion, and when coupled to an accessory panel (3) as depicted in FIGS. 3 and 6. The test mobile phone is fitted with a built-in bending wave panel and exciter loudspeaker system that produces the result shown in the thickest line. The measurement is taken at 1 meter with the test mobile phone resting on a large flat surface to represent a desk or similar object. The bending wave panel speaker of the test mobile phone is facing upwards and the measurement microphone is directly above it. The test mobile phone measures 50 mm by 100 mm by 12 mm thick and has a mass of 45 grams. The bending wave panel of the test mobile phone measures 38 mm by 47 mm and is made of 1 mm polycarbonate. All measurements are carried out with the same drive level from the amplifier.

The accessory device which forms the bending wave radiator (3) measures 230 mm by 320 mm by 2 mm thick and is made from “Acoustic 66” material. A convex coupler dome (2) and four feet (6) were fitted in accordance with DML design rules as set out in WO97/09842 and U.S. application Ser. No. 08/707,012 so as not to unduly affect the performance of the panel.

The thinnest curve shows the result of the accessory radiator (3) when lying flat on a large surface, as depicted in FIG. 6. The accessory panel (3) is spaced from the surface by its four feet (6) to a height of 6 mm. The test mobile phone (4) is placed on the accessory device such that the coupler dome (2) rests at the excitation position of the test mobile phone bending wave panel. The coupling force is obtained from the weight of the test mobile phone only and no additional fixings were used. Two small feet (5) were fitted to the test mobile phone to give a tripod support when used collectively with the dome coupler (2). These feet space the test mobile phone at a distance of 3 mm from the accessory panel (3). The response is measured as previously described. It is clear that the bandwidth has been substantially improved, with useful output down to 700 Hz as opposed to 2.5 kHz obtained with the test mobile phone on its own. There are no substantial changes to the high frequency performance. The average sensitivity can be seen to have also increased over the usable range with particular emphasis to the speech intelligibility range of 1 to 3 kHz.

The medium thickness curve shows the performance with the accessory panel (3) now supported as depicted in FIG. 3. The angle of the panel (3) was set to 75 degrees to the horizontal as this still allows coupling by gravity alone, and no clip (9) was required. The measurement was carried out at 1 meter, parallel to the horizontal and aligned with the centre of the accessory panel. This curve shows that the usable bandwidth has now increased further and there is useful output down to 320 Hz. The sensitivity over the usable range is no higher than the test mobile phone but the sensitivity-bandwidth product has increased substantially. In this configuration the sound quality is exceptional when compared with the test mobile phone alone. The increased bandwidth allows for speech or music reproduction with clarity and sufficient volume to fill a small room.

1. The combination of a personal portable communications device having an audio output intended for use when proximate to a user's ear, and a physically separable accessory to amplify the audio output of the communication device for remote reception, the accessory comprising a bending wave panel-form acoustic radiator, and the communications device comprising a vibration transducer capable of being detachably coupled to the radiator to drive bending wave energy into the radiator to produce an acoustic output therefrom.

2. The combination of claim 1, wherein the radiator is formed with ground engaging feet adapted to support the radiator above a ground surface.

3. The combination of claim 2, wherein the ground engaging feet support the radiator at an acute angle with respect to the ground surface.

4. The combination of claim 1, claim 2 or claim 3, wherein the communications device is adapted to be supported on the radiator, whereby coupling of the vibration transducer to the radiator is at least partially by gravity.

5. The combination of claim 4, wherein the radiator is formed with a raised coupler portion that is adapted to operatively engage the vibration transducer.

6. The combination of claim 5, wherein the raised coupler portion is domed.

7. The combination of claim 5, wherein the raised coupler portion comprises one part of a locking coupling.

8. The combination of claim 7, wherein the radiator is formed with a support for the communications device that spaces the communications device above the radiator.

9. The combination of claim 1, claim 2 or claim 3, wherein the radiator is formed with a raised coupler portion that is adapted to operatively engage the vibration transducer.

10. The combination of claim 9, wherein the raised coupler portion is domed.

11. The combination of claim 9, wherein the raised coupler portion comprises one part of a locking coupling.
